(19) United States
(12) Patent Application Publication
(10) Pub. No.: US 2026/0349065 A1
(43) Pub. Date: Nov. 5, 2026

(54) LOCALISATION METHOD AND APPARATUS IMPLEMENTING THE METHOD

(71) Applicant: AUMOVIO Germany GmbH, Frankfurt am Main (DE)

(72) Inventors: David GONZALEZ GONZALEZ, Egelsbach, Hessen (DE); Osvaldo GONSA, Frankfurt (DE); Niclas Günter Jürgen FÜHRLING, Bremen (DE); Giuseppe Thadeu FREITAS DE ABREU, Bremen (DE)

(73) Assignee: AUMOVIO Germany GmbH, Frankfurt am Main (DE)

(21) Appl. No.: 19/484,014

(22) PCT Filed: May 17, 2024
(86) PCT No.: PCT/IB2024/054821

§ 371 Date: Nov. 13, 2025

(30) Foreign Application Priority Data
May 17, 2023 (DE) 102023204638.5
Jul. 14, 2023 (DE) 102023118773.2

(51) Int. Cl. G01S 5/02

(52) U.S. Cl. CPC G01S 5/02524; G01S 5/0273

(57) ABSTRACT

A method of locating objects emitting wireless signals, in an environment having at least two receivers adapted to RSS values of the object's wireless signals is presented. The at least two receivers have known positions and are communicatively connected to a common computing unit. The method includes, at the common computing unit, determining an optimised RSS value-based coordinate mapping function considering line-of-sight paths and non-line-of-sight paths, using the known positions of the receivers, reflectors and training objects. The RSS values for the objects and from each of the two or more receivers are aggregated, and are arranged into a received signal power vector containing, for each individual object, the sums of the RSS values determined at all receivers. For each object, vectors containing the RSS values received by the two or more receivers are mapped onto x and y coordinates of the environment using the optimised mapping function.

### CROSS REFERENCE TO RELATED APPLICATIONS

This application is the U.S. National Phase Application of PCT International Application No. PCT/IB2024/054821, filed May 17, 2024, which claims priority to German Patent Application Nos. DE10 2023 204 638.5, filed May 17, 2023, and DE10 2023 118 773.2, filed Jul. 14, 2023, the contents of such applications being incorporated by reference herein.

### FIELD OF THE INVENTION

The present invention relates to the field of object localisation using wireless signals emitted by the objects, in particular wireless communication signals.

### NOTATIONS

Throughout this specification, bold symbols represent vectors or matrices. Scalar values are denoted herein by lowercase letters in italics, as in x. Superscripts T and H, respectively denote the transpose and complex conjugate transpose of a vector or matrix.

### BACKGROUND OF THE INVENTION

Wireless localisation technology, both indoors and outdoors, has gained great attention and development in the last few decades, inter alia in connection with autonomous vehicles, where knowing a vehicle's location is essential for safe and efficient operation. Localisation information can further be used for tracking vehicles and predicting their paths, which may be useful for collision prevention or detection. Other uses of wireless localisation include near-field radio frequency identification (RFID) positioning and Internet-of-Things (IoT) sensor networks in smart factories and homes.

Traditional localisation techniques have typically relied on global navigation satellite systems (GNSS) for the satellite-based geolocation and time information, but such methods exhibit poor power-efficiency, precision, latency, and robustness in dense urban scenarios, especially for the expected requirements of beyond fifth-generation (B5G) communication applications.

Therefore, alternative positioning systems have been investigated to utilize wireless signals from a more proximate environment, such as wireless sensors, devices, and access points, capable of capturing signal metrics such as time of arrival (ToA), angle of arrival (AoA), or received signal strength (RSS) values. Such localisation scenarios generally resolve to a multidimensional, multivariate optimisation problem based on the received signal metrics from the sensors, where the position information of the targets is the solution.

In order to alleviate such challenging optimisation problem, recently proposed methods leverage machine learning (ML) techniques.

For example, in “Autonomous 3d UAV localisation using Taylor series linearized TDoA-based approach with machine learning algorithms,” 2022 13th International Conference on Information and Communication Technology Convergence (ICTC), 2022, pp. 783-785, incorporated herein by reference, V. Tilwari and S. Pack, suggest using a supervised ML method to evaluate Taylor series-linearized time difference of arrival (TDOA) measurements to localize autonomous unmanned aerial vehicles. In “A deep learning based AoA estimation method in NLOS environments,” 2021 IEEE Globecom Workshops (GC Wkshps), 2021, pp. 1-6, incorporated herein by reference, Y. M. T. Wang and Y. Shen use a deep residual network for evaluating AoA measurements for a single sensor non-line-of-sight (NLOS) indoor environment.

A method to incorporate heterogeneous sensor information was proposed by N. T. A. M. I. Al Hajri and R. M. Shubair, in “Indoor localisation for IoT using adaptive feature selection: A cascaded machine learning approach,” IEEE Antennas and Wireless Propagation Letters vol. 18, no. 11, pp. 2306-2310 November 2019, incorporated herein by reference. There, a K-nearest-neighbour (KNN) algorithm is used to adaptively select and combine the various signal radio frequency (RF) features for indoor localisation.

An increasingly popular technique is to only operate with RSS values at the sensors, with the advantageous trait that the encoded information of the wireless signal itself is not relevant, such that it can be used for other applications such as communication or channel estimation. For example, in “RSS-based multiple sources localisation with unknown log-normal shadow fading,” arXiv:2110.10435v1, 2021, incorporated herein by reference, Y. Chu, W. Guo, K. You, L. Zhao, T. Peng, and W. Wang suggest detecting RSS values at distributed sensors and use this information to localize the signal-emitting targets on a discrete grid. The positions of the targets are initially estimated via a sparse dictionary updating and a K-means clustering, and are iteratively refined by a dynamic update of the dictionary.

While the prior art methods provide viable solutions for specific environments and scenarios, they provide sub-optimal accuracy and are mostly suitable for limited indoor environments only.

### SUMMARY OF THE INVENTION

It is, therefore, desirable to provide a localisation method that exhibits improved robustness and accuracy in noisy environments, and an apparatus implementing the method.

An aspect of the invention will be described in the following assuming a multi-user (MU) distributed massive multiple-input multiple-output (DM-MIMO) scenario, consisting of K single-antenna transmit devices, also referred to herein as objects or targets, which are served by M single-antenna remote radio heads (RRHs), also referred to herein as receivers or sensors, the latter being connected to a computing unit (CU) via error-free fronthaul links with infinite rate, as schematically depicted in FIG. 1. The radio signals emitted from the objects are received at the multiple receivers at different signal strengths, depending on their respective distances. Throughout the following specification the terms RSS and RSSI may be used interchangeably for the received signal strength.

The two-dimensional (2D) positions of the m-th receiver and the k-th objects, with m∈M≙{1, . . . , M} and k∈K≙{1, . . . , K}, are respectively described by the 2D coordinate vectors

$${c}_{m}^{SN} {=}^{Δ} [ \begin{matrix}{x}_{m}^{SN} \\ {y}_{m}^{SN}\end{matrix} ] ∈ {ℝ}^{2 \times 1} , and {c}_{k}^{TG} {=}^{Δ} [ \begin{matrix}{x}_{k}^{TG} \\ {y}_{k}^{TG}\end{matrix} ] ∈ {ℝ}^{2 \times 1} , \qquad ( 1 )$$

where

$${x}_{m}^{SN} , {y}_{m}^{SN} and {x}_{k}^{TG} , {y}_{k}^{TG} .$$

are respectively the x- and y-coordinates of the m-th receiver and k-th object.

Following the above, the Euclidean distance between the m-th receiver and the k-th object is given by

$${d}_{mk} A {=}^{Δ} {‖ {c}_{m}^{SN} - {c}_{k}^{TG} ‖}_{2} ∈ ℝ . \qquad ( 2 )$$

Considering a single line-of-sight (LOS) path, the received signal vector at the m-th receiver over T consecutive transmission instances is given by

$${r}_{m} = {\sum }_{k = 1}^{K} {h}_{mk} \sqrt{{ρ}_{k}} {ω}_{k} + {v}_{m} ∈ {ℂ}^{T \times 1} , \qquad ( 3 )$$

where rₘ∈ [symbol] is the received symbol at the m-th receiver, hₘₖ∈ [symbol] is the flat-fading uplink channel gain between the m-th receiver and the k-th object, assumed to remain constant during T consecutive transmissions, ρₖ∈ [symbol] and ωₖ∈ [symbol] ^{T×1} are respectively the transmit power and the arbitrary transmit symbol vector from the k-th object, and

$${v}_{m} ∼ XN ( 0 , {σ}_{v}^{2} \cdot {I}_{T} ) ∈ {ℂ}^{T \times 1}$$

is the additive white Gaussian noise (AWGN) received at the m-th receiver. In this specification it is assumed that the transmit powers of all objects are uniform, such that ρₖ=ρ, ∀k∈K.

The flat-fading uplink channel gain coefficient hₘₖ in equation (3) is further modelled by

hₘₖ=qₘₖ\sqrt{gₘₖ}∈ [symbol] (4)

where qₘₖ~XN(0,1) is the small-scale fading factor, and gₘₖ is the large-scale fading factor given by

$${g}_{mk} = {b}_{0} {d}_{mk}^{- η} 1 {0}^{( {z}_{mk} / 10 )} ∈ ℝ , \qquad ( 5 )$$

with b₀∈ [symbol] representing the reference path loss coefficient, i.e., the path loss at a reference distance, and η∈ [symbol] representing the path loss exponent determined by environmental assumptions.

$${d}_{mk} ∈ ℝ and {z}_{mk} ∼ N ( 0 , {σ}_{{z}_{mk}}^{2} )$$

are respectively the distance as defined in equation (2) and the channel gain due to random shadowing of the path between the m-th receiver and the k-th object.

In light of the above, the RSSI value of the received signal at a receiver is obtained by

$${p}_{m} {=}^{Δ} {\vert {r}_{m} \vert}^{2} = {\sum }_{k = 1}^{K} {\overbrace{{\vert {h}_{mk} \sqrt{ρ} {ω}_{k} \vert}^{2}}}^{{=}^{Δ} {p}_{mk}} + {\vert {v}_{m} \vert}^{2} ∈ ℝ , \qquad ( 6 )$$

where pₘₖ∈ [symbol] is the RSS value of the k-th transmitter received at the m-th receiver, described by

pₘₖ=ρ·gₘₖ|qₘₖ|²∈ [symbol] (7)

which can be estimated—either semi-blindly by leveraging short orthogonal pilot sequences together with independent payload data, or blindly by exploiting the sparsity resulting from intermittent user activity, such that only a relatively small random subset of transmitters share the channel at each transmission instance—based on the relation

$$\frac{1}{{T}^{2}} diag ( {W}^{H} \cdot {r}_{m} \cdot {r}_{m}^{H} \cdot W ) \vec{T ⪢ K} \frac{1}{K} {p}_{m} + \frac{{σ}_{v}^{2}}{T} {I}_{K} \qquad ( 8 )$$

where W≙[ω₁ . . . ω_{K}] and pₘ≙[pₘ₁ . . . p_{mK}]^{T}, respectively, denote a matrix collecting the transmit signals and the powers from all K transmitters at the m-th receiver.

The powers pₘₖ can be equivalently expressed in decibel (dB) scale as

$${p}_{mk}^{dB} {=}^{Δ} max ( {p}_{0}^{dB} - η \cdot {d}_{mk}^{dB} , {ζ}^{dB} ) + {z}_{mk} ∈ ℝ , \qquad ( 9 )$$

where

$${p}_{0}^{dB} {=}^{Δ} 10 {log}_{10} ( ρ \cdot {b}_{0} ) , {d}_{mk}^{dB} {=}^{Δ} 10 {log}_{10} ( {d}_{mk} )$$

and ζ^{dB} is the radio sensitivity.

Consequently, the RSSI values from all M RRHs are aggregated at the CU, and stacked into a vector (in dB) as

$${p}_{k} {=}^{Δ} {[ {p}_{1 k}^{dB} , ⋯ , {p}_{M k}^{dB} ]}^{⊤} ∈ {ℝ}^{M \times 1} . \qquad ( 10 )$$

It is to be noted that the RSS system model described above only captures the signals from a direct LOS path.

Therefore, for increasing the diversity of the system, an aspect of the invention proposes including multipath signal propagation, in particular NLOS paths, which can arise by introducing reflectors, such as reconfigurable intelligent surfaces (RIS), as illustrated in FIG. 2. The LOS path is the direct path between the object k and the receiver m, while the NLOS path has two segments

$${d}_{k , ℓ}^{1} , {d}_{k , ℓ}^{2} ,$$

one segment between the receiver m and the reflector [symbol] , and the other segment between the reflector [symbol] and the object k. The RISs may be of the kind as discussed by G. Wu, F. Li, and H. Jiang, in “Analysis of multipath fading and doppler effect with multiple reconfigurable intelligent surfaces in mobile wireless networks,” Wireless Communications and Mobile Computing, vol. 2022, pp. 1-15, 012022.

To this end, the system model presented further above for the LOS scenario is extended to also incorporate those NLOS paths. By assuming that the reflector is an ideal tangential reflector about a point such that a reflection can occur from any direction, a 2D coordinate vector of the [symbol] -th reflector, with [symbol] ∈ [symbol] ≙{1, . . . , L}, is given by

$${c}_{ℓ}^{R} {=}^{Δ} [ \begin{matrix}{x}_{ℓ}^{R} \\ {y}_{ℓ}^{R}\end{matrix} ] ∈ {ℝ}^{2 \times 1} \qquad ( 11 )$$

where

$${x}_{ℓ}^{R} , {y}_{ℓ}^{R}$$

are the x- and y-coordinates of the [symbol] -th reflector. Consequently, the NLOS distance [symbol] between the m-th receiver and the k-th object, reflected at the [symbol] -th reflector, is given by

$${d}_{mk , ℓ} {=}^{Δ} {d}_{k ℓ}^{1} + {d}_{m ℓ}^{2} ∈ ℝ , \qquad ( 12 )$$

where

$${d}_{k ℓ}^{1} ∈ ℝ and {d}_{m ℓ}^{2} ∈ ℝ$$

are the distances of the first and second components of the NLOS path, respectively describing the path from the k-th object to the [symbol] -th reflector, and the path from the [symbol] -th reflector to the m-th receiver, given by

$${d}_{k ℓ}^{1} {=}^{Δ} {‖ {c}_{k}^{T} - {c}_{ℓ}^{R} ‖}_{2} ∈ ℝ , \qquad ( 13 )$$

$${d}_{m ℓ}^{2} {=}^{Δ} {‖ {c}_{m}^{S} - {c}_{ℓ}^{R} ‖}_{2} ∈ ℝ .$$

In light of the above, and by assuming that that the reflection loss and the temporal delays between the multipath received signals are negligible, the received signal model from equation (3) can be extended as

$${r}_{m} = \sqrt{ρ} {\sum }_{k = 1}^{K} {\sum }_{ℓ = 1}^{L} {h}_{mk , ℓ} {ω}_{k} + {v}_{m} \qquad ( 14 )$$

where each channel coefficient [symbol] ∈ [symbol] is defined similarly to equation (4), but for different path distances as

[symbol]

= [symbol] [symbol] (15)

where [symbol] ~XN(0,1) is the small-scale fading factor of the [symbol] -th NLOS path between the m-th receiver and the k-th object. The corresponding large-scale fading factor is given by

$${g}_{mk , ℓ} = {b}_{0} {d}_{mk , ℓ}^{- η} {10}^{( {z}_{mk , ℓ} / 10 )} \qquad ( 16 )$$

where [symbol] ∈ [symbol] and

$${z}_{mk} ∼ N ( 0 , {σ}_{{z}_{mk , ℓ}}^{2} )$$

respectively the distance and the shadowing noise gain of the [symbol] -th NLOS path between the m-th receiver and the k-th object.

Consequently, the RSS values and parameters defined further above are correspondingly redefined with the multipath assumptions by following

$${p}_{mk , ℓ}^{dB} = {p}_{0}^{dB} - η \cdot {d}_{mk , ℓ}^{dB} + {z}_{mk , ℓ} ∈ ℝ , \qquad ( 17 )$$

$$p = {\sum }_{k = 1}^{K} {\sum }_{ℓ = 1}^{L} {\underbrace{{[ {p}_{1 k , ℓ}^{dB} , … , {p}_{Mk , ℓ}^{dB} ]}^{T}}}_{{=}^{Δ} {p}_{m , ℓ}} ∈ {ℝ}^{M \times 1} . \qquad ( 18 )$$

The incorporation of the additional NLOS paths for each receiver-object pair increases the diversity of the system, expected at least L-fold, such that a multipath localisation algorithm performs significantly better under the same number of receivers against the single-path models, or in other words, the multipath localisation algorithm can reach the performance of the single-path models with a significantly smaller number of required receivers.

Equations (11) to (18) that form the extension to multipath can be inserted into the processing discussed hereinafter. Note that the processing discussed below is provided for completeness only and focuses on a single-path model. Implementing the multi-path extension in accordance with an aspect of the present invention requires replacing the original equations (1) to (10) derived above for the single-path model, where appropriate.

The multi-object multipath problem presented above will require a suitable solution for obtaining a viable implementation. In accordance with an aspect of the present invention an ML-based solution to the multi-object multipath localisation problem is presented, which effectively translates to an optimisation problem over the K pairs of real-valued 2D coordinates, given the aggregated RSS values at the M RRHs and the known positions of the M RRHs and the L reflectors. Specifically, the proposed solution is elaborated hereinafter in three subsections, dealing with a Gaussian process (GP-) based coordinate model of the objects, a robust training method via SGD, and a localisation algorithm to approximate the unknown coordinates using GP methods.

In the following subsection the coordinate model upon which the location is based will be discussed, considering two arbitrary functions fₓ(⋅) and f_{y}(⋅) that map the received signal power vector of any k-th object to its x- and y-coordinates, respectively, i.e.,

$${x}_{k}^{T} = {f}_{x} ( {p}_{k} ) , and {y}_{k}^{T} = {f}_{y} ( {p}_{k} ) ∀ k ∈ K \qquad ( 19 )$$

Implying that if the functions fₓ(⋅) and f_{y}(⋅) are known at the CU, the positions of any object can be obtained, provided the aggregated RSSI values.

Remark: As the expressions are identical for the x-coordinate and the y-coordinate functions and derivations, the subscripts (⋅)ₓ and (⋅)_{y} are omitted for conciseness from this point onward, and the following expressions are assumed to apply identically for both x- and y-coordinates unless stated otherwise. Occasionally, the letter c may be used, indicating either interchangeably.

In the proposed method, GPR is utilized to model the coordinate mapping functions, where it is first assumed that the target function is drawn from a user-defined GP prior, i.e.,

f(⋅)~Γπ(0,Φ) (20)

where Γπ(0, Φ) denotes the GP prior with zero mean and covariance matrix Φ∈ [symbol] ^{K×K}, whose element at the k-th row and q-th column is given by the covariance function φ(pₖ, p_{q}) given the RSSI values between the object k and q.

To accurately model the relationship of the RSSI values and the coordinates, the covariance function must be designed to carefully capture the differences in power between any two objects in the region of interest (ROI). The proposed method follows the covariance function proposed by K. N. R. S. V. Prasad, E. Hossain, and V. K. Bhargava, in “Machine learning methods for RSS-based user positioning in distributed massive MIMO,′ IEEE Transactions on Wireless Communications, vol. 17, no. 12, pp. 8402-8417, 2018, which is designed to capture both stationary and non-stationary transmitter object pairs, as

$$ϕ ( {p}_{k} , {p}_{q} ) = α {e}^{- 0.5 {( {p}_{k} - {p}_{q} )}^{T} {B}^{- 1} ( {p}_{k} - {p}_{q} )} + γ {p}_{k}^{T} {p}_{q} + {σ}_{er}^{2} {δ}_{kq} \qquad ( 21 )$$

where pₖ∈ [symbol] ^{M×1} and p_{q}∈ [symbol] ^{M×1} are respectively the RSS vectors of the k-th and q-th object,

$${σ}_{er}^{2} ∈ ℝ$$

is the variance the measurement error, δ_{kq} is the indicator variable taking on the value 1 if k=q and 0 if k≠q, and the parameters α, B, γ are the weight parameters to be learned, with

B≙diag([β₁, . . . ,β_{M}])∈ [symbol] ^{M×M}, (22)

where βₘ∈ [symbol] ∀m∈M are the weights corresponding to each RSSI vector in the exponential term of the covariance function defined in equation (21).

In light of the discussion above relating to the coordinate model, it can be seen that in hand of the RSS vectors yielding to the covariance matrix, the actual coordinate value can be obtained by evaluating the mean of the GP f(⋅) in equation (20). This requires the information of the M+2 unknown weight parameters α, β₁, . . . , β_{M}, γ of the covariance function, whose ML-based optimisation is described hereinafter.

For convenience, the vector collecting the M+2 unknown weight parameters is defined as

θ≙[α,β1, . . . ,β_{M},γ]^{T}∈ [symbol] ^{(M+2)×1}. (23)

Also define the sets of coordinates c∈ [symbol] ^{K×1} corresponding to K training locations, and the associated set of training RSSI vectors pₖ∈ [symbol] ^{M×1}, with k=1, . . . , K. Accordingly, also define the training covariance matrix Ψ∈ [symbol] ^{K×K} associated with the K training locations and corresponding RSSI values, and the cross-covariance matrix Σ∈ [symbol] ^{K×K} between the K training and the K target object locations, constructed from the corresponding sets of RSSI values, respectively. Then, the joint distribution of the coordinate vectors of the training and target object locations, according to a conventional GP approach, is given by,

$$ℙ ( [ \begin{matrix}c \\ c\end{matrix} ] \vert {ρ}_{1} , … , {ρ}_{K} , {p}_{1} , … , {p}_{K} , θ ) = N ( 0 , [ \begin{matrix}Ψ & {\sum }^{T} \\ \sum & Φ\end{matrix} ] ) \qquad ( 24 )$$

where the k-th row and k th column of the cross-covariance matrix Σ∈ [symbol] ^{K×K} between the training RSS and the actual RSS data is given by φ(p_{K} pₖ), as obtained from equation (21).

In possession of the joint distribution in equation (24), the conditional distribution of c is given by

[symbol]

(c|c,p₁, . . . ,p_{K},p₁, . . . ,pₖ,θ)=N(μ,C) (25)

where the conditional mean vector μ∈ [symbol] ^{K×1} and covariance matrix C∈ [symbol] ^{K×K} is obtained via

μ=ΣΨ⁻¹c∈ [symbol] ^{K×1} (26a)

C=Φ−ΣΨ⁻¹Σ^{T}∈ [symbol] ^{K×K} (26b)

Thus, the marginal distribution of the individual object coordinate can be obtained as

[symbol]

(c|c,p₁, . . . ,p_{K},pₖ,θ)=N(cₖ,vₖ) (27)

where cₖ and vₖ are respectively the marginal mean and variance of the estimate of the coordinate of the k-th object, given by

$${c}_{k} = {\sum }_{k = 1}^{K} ϕ ( {p}_{k} , {ρ}_{k} ) \cdot {[ {Ψ}^{- 1} c ]}_{k} \qquad ( 28 a )$$

$${v}_{k} = ϕ ( {p}_{k} , {ρ}_{k} ) - {\sum }_{k = 1}^{K} {\sum }_{i = 1}^{K} ϕ ( {p}_{k} , {ρ}_{k} ) \cdot {[ {Ψ}^{- 1} ]}_{k , i} \cdot ϕ ( {ρ}_{i} , {p}_{k} ) \qquad ( 28 b )$$

where [⋅]ₖ and [⋅]_{k,i}, respectively, denote the k th element of a vector and the matrix element at the k-th row and i-th column.

Since cₖ is Gaussian distributed, the marginalized mean cₖ is directly the maximum-a-posteriori estimate of xₖ, and hence the final predicted coordinate of the k-th target.

It can be inferred from the procedure described above that the performance of the GPR-based RSSI localisation algorithm is highly dependent on the accuracy of the covariance matrix model given in equation (21), which in turn is fundamentally determined by the parameter vector θ. Consequently, a core step of the inventive method is to optimally determine θ, given a certain amount of training data.

In “Machine learning methods for RSS-based user positioning in distributed massive MIMO,” incorporated herein by reference, this is achieved via a maximum likelihood fitting of the distribution of the training coordinates c, given the corresponding set of K RSSI vectors pₖ, assumed to be free of errors. Such an assumption is not only virtually impossible to meet in practice, as assuming error-free RSSI implies the need for pilot signals of either extremely high power or in extremely large numbers, which is already idealistic in the case of a single transmitter-sensor pair, let alone in the multitarget-multisensor setting under consideration, but also a cause of poor performance in real-life applications, since the inevitable presence of errors in RSSI values collected is not mitigated by design.

Embodiments of the multi-object multipath localisation method presented herein adopt using noisy training data for obtaining a viable implementation under non-ideal, i.e., real-world, circumstances. In these embodiments of the invention the variance of the shadowing noise is incorporated in the training phase in addition to the deterministic, i.e., noise-free, training RSS values, which yields a more noise-robust ML prediction model than known methods that do not incorporate the noise in the training phase. In the following discussion noisy training data is assumed, although it is readily apparent that the method using LOS and NLOS signals can easily be adapted to ideal conditions without noise.

In accordance with embodiments of the invention the problem of robustness against noise will be addressed by determining the parameter vector θ using noisy training data, lending both feasibility and robustness to the overall location method. Using noisy training data affected by random shadowing noise reflects the real-world scenario, in which the actual signals are likewise affected by random shadowing noise, and thus distinguishes the present method from the known location methods, which assume a perfect match between the training data and the base model.

In other words, similarly to measured target RSSI values utilized in the actual localisation operation of the method, the training RSSI vectors used to obtain the optimal parameter vector θ are modelled as

$${ρ}_{K} = {p}_{0}^{dB} \cdot {1}_{M \times 1} - η \cdot [ {d}_{1 k}^{dB} , … , {d}_{Mk}^{dB} ] + [ {z}_{1 k} , … , {z}_{M k} ] \qquad ( 29 )$$

with

$${z}_{mk} ∼ N ( 0 , {σ}_{{z}_{m k}}^{2} ) .$$

it should be noted that equation (29) describes a single-path model without the loss of generality to the multi-path model.

This is equivalent to treating the coordinates c of the training points not as deterministic, but rather as random variables with a distribution that, under the GPR model can be assumed to be approximated by

[symbol]

(c|p₁, . . . ,p_{K},θ)≈N(O_{K×1},Ψ) (30)

where the elements of the covariance matrix Ψ∈ [symbol] ^{K×K} are determined via equation (29), that is

$$Ψ {=}^{△} [ \begin{matrix}ϕ ( {p}_{1} , {p}_{1} \vert θ ) & ⋯ & ϕ ( {p}_{1} , {p}_{K} \vert θ ) \\ ⋮ & ⋱ & ⋮ \\ ϕ ( {p}_{K} , {p}_{1} \vert θ ) & ⋯ & ϕ ( {p}_{K} , {p}_{K} \vert θ )\end{matrix} ] ∈ {ℝ}^{K \times K} \qquad ( 31 )$$

Given the distribution in equation (30), the optimal weight parameters θ can then be determined as the solution of the maximum likelihood problem

$${θ}^{*} = {argmin}_{θ} {\overbrace{- log ( ℙ ( c \vert {p}_{1} , … , {p}_{K} , θ ) )}}^{{=}^{△} g ( θ ; {p}_{1} , … , {p}_{K} )} \qquad ( 32 )$$

where the objective g(θ; p₁, . . . , p_{K}) is implicitly defined, which for the purpose of training is a function of the parameter vector θ, as highlighted by the notation, and which in view of the Gaussian approximation in equation (30), can be modelled as

$$g ( θ ; {p}_{1} , … , {p}_{K} ) = \frac{1}{2} log ( {( 2 π )}^{K} \vert Ψ \vert ) + \frac{1}{2} {c}^{T} {Ψ}^{- 1} c \qquad ( 33 )$$

where |⋅| denotes the determinant of the argument matrix.

It is evident from equations (21), (31), and (33), that g(θ; p₁, . . . , pₖ) is not convex on the optimisation variable θ. In fact, the determinant and inversion operations onto Ψ, and the nonlinear dependence of the latter on the parameters βₘ gathered in the matrix B, render the problem highly intractable from the perspective of optimisation theory.

An aspect of the present invention addresses this non-convexity issue via an SGD approach discussed by S. Ruder, in “An overview of gradient descent optimisation algorithms,” 2016, arXiv:1609.04747.

In the context of an aspect of the present invention, first consider the partial derivative of that g(θ; p₁, . . . , p_{K}) with respect to α, which is given by

$$\frac{\partial g ( θ ; {p}_{1} , … , {p}_{K} )}{\partial α} = \frac{\partial }{\partial α} ( \frac{1}{2} log ( {( 2 π )}^{K} \vert Ψ \vert ) + \frac{1}{2} {c}^{T} {Ψ}^{- 1} c ) = \frac{1}{2} ( \frac{\partial }{\partial α} log \vert Ψ \vert ) + \frac{1}{2} {c}^{T} ( \frac{\partial }{\partial α} {Ψ}^{- 1} ) c . \qquad ( 34 )$$

Next, the matrix derivative identities are leveraged, as discussed by K. Petersen and M. Pedersen, in “The Matrix Cookbook”, Lyngby, Denmark: Technical Univ. Denmark, 2006:

$$\frac{\partial \vert Ψ \vert}{\partial α} = \vert Ψ \vert \cdot Tr ( {Ψ}^{- 1} \frac{\partial Ψ}{\partial α} ) and \frac{\partial {Ψ}^{- 1}}{\partial α} = - {Ψ}^{- 1} \frac{\partial Ψ}{\partial α} {Ψ}^{- 1} \qquad ( 35 )$$

to simplify the expression in equation (34) to

$$\frac{\partial g ( θ ; {p}_{1} , … , {p}_{K} )}{\partial α} = \frac{1}{2} Tr ( {Ψ}^{- 1} \cdot \frac{\partial Ψ}{\partial α} ) - \frac{1}{2} {c}^{T} {Ψ}^{- 1} \frac{\partial Ψ}{\partial α} {Ψ}^{- 1} c = \frac{1}{2} Tr ( {Ψ}^{- 1} \cdot \frac{\partial Ψ}{\partial α} ) - {Ψ}^{- 1} \frac{\partial Ψ}{\partial α} \qquad ( 36 )$$

Observing that the partial derivatives of equation (33) with respect to βₘ and γ are identical in form to the expression in equation (36), details of the derivations corresponding to the latter parameters are omitted herein, and only expressions for each element of the partial derivatives of Ψ with respect to α, βₘ, and γ are provided, which are respectively given by

$${[ \frac{\partial Ψ}{\partial α} ]}_{k , i} = exp ( - \frac{1}{2} {\overline{p}}_{ki}^{T} {B}^{- 1} {\overline{p}}_{ki} ) \qquad ( 37 a )$$

$${[ \frac{\partial Ψ}{\partial {β}_{m}} ]}_{k , i} = \frac{α \cdot {[ {\overline{p}}_{ki} ]}_{m}}{2 {( {β}_{m} )}^{2}} \cdot exp ( - \frac{1}{2} {\overline{p}}_{ki}^{T} {B}^{- 1} {\overline{p}}_{ki} ) \qquad ( 37 b )$$

$${[ \frac{\partial Ψ}{\partial γ} ]}_{k , i} = {p}_{k}^{T} {p}_{i} \qquad ( 37 c )$$

where [p̅ₖᵢ]ₘ is the m-th element of p̅ₖᵢ≙(pₖ−pᵢ)∈ [symbol] ^{M×1}, and the notation [⋅]_{k,i} denotes the matrix element at the k-th row and the i-th column.

The gradient of the objective function in (33) can then finally be put together, yielding

$$▽g ( θ ; {p}_{1} , … , {p}_{K} ) = [ \begin{matrix}\begin{matrix}\begin{matrix}\begin{matrix}\frac{\partial g}{\partial α} \\ ⋮\end{matrix} \\ \frac{\partial g}{\partial {β}_{m}}\end{matrix} \\ ⋮\end{matrix} \\ \frac{\partial g}{\partial γ}\end{matrix} ] = \frac{1}{2} [ \begin{matrix}\begin{matrix}\begin{matrix}\begin{matrix}Tr ( {Ψ}^{- 1} \frac{\partial Ψ}{\partial α} ) \\ ⋮\end{matrix} \\ Tr ( {Ψ}^{- 1} \frac{\partial Ψ}{\partial {β}_{m}} )\end{matrix} \\ ⋮\end{matrix} \\ Tr ( {Ψ}^{- 1} \frac{\partial Ψ}{\partial γ} )\end{matrix} ] - {Ψ}^{- 1} c \cdot [ \begin{matrix}\begin{matrix}\begin{matrix}\begin{matrix}\frac{\partial Ψ}{\partial α} \\ ⋮\end{matrix} \\ \frac{\partial Ψ}{\partial {β}_{m}}\end{matrix} \\ ⋮\end{matrix} \\ \frac{\partial Ψ}{\partial γ}\end{matrix} ] \qquad ( 38 )$$

such that the parameter vector θ can be optimized via gradient descent (GD), according to the update equation

θ⁽ⁱ⁾←⁽ⁱ⁻¹⁾−λ·∇g(θ⁽ⁱ⁻¹⁾,p₁, . . . ,p_{K}) (39)

where θ⁽ⁱ⁻¹⁾ and θ⁽ⁱ⁾ are the parameter vectors at the (i−1)-th and i-th SGD iterations, respectively, while λ is the learning rate, which for convergence guarantees is bounded by the Lipschitz condition

$$0 \leq λ \leq \frac{1}{L} \qquad ( 40 a )$$

with L denoting the Lipschitz constant, given by

L=max eig((Ψ⁻¹)^{T}·Ψ⁻¹) (40b)

where max eig(⋅) denotes the operator returning the maximum eigenvalue of the argument matrix.

The training procedure described above may be performed over a large data set, consisting of multiple snapshots of data collected for a large number of training locations, as exemplarily depicted by the ‘training cube’ Δ in FIG. 3. The training data cube Δ∈ [symbol] ^{M×K×S} consists of S noisy snapshots of each and all RSSI vectors

$${p}_{k}^{( s )} ,$$

with k∈{1, . . . , K} and s∈{1, . . . , S}, as illustrated in FIG. 3. The exemplary training cube Δ corresponds to a case where the number of sensors is M=5, the number of training locations is K=7, the total number of snapshots of RSSI vectors per training location is S=8.

Since the complexity of the training method is fundamentally determined by the inversion of the covariance matrix Ψ, as evident from equation (38), embodiments of the present invention further propose applying a mini-batch SGD-based variation of the training scheme outlined above, which will be described below, aiming at lowering the complexity of its implementation. Here, the total training data is split into T mini-batches of size S, for multiple applications of the SGD algorithm.

A mini-batch Δ_{b}∈ [symbol] ^{M×\tilde{k}}⊂Δ consists of a number \tilde{K}<<K of training RSSI vectors

$${p}_{\tilde{k}}^{( \tilde{s} )} ,$$

selected randomly from Δ, with equal probability and mutually exclusively, such that \tilde{k}∈{1, . . . , \tilde{K}} and \tilde{s}∈{1, . . . , S}. For notational convenience, the training locations are relabelled corresponding to a given b-th mini-batch as \tilde{c}_{b}=[\tilde{x}₁, . . . , \tilde{x}_{\tilde{K}}], and the corresponding RSSI vectors as \tilde{p}_{\tilde{k}}, such that the mini-batch can be described as Δ_{b}=[\tilde{p}₁, . . . , \tilde{p}_{\tilde{K}}].

An example of a mini-batch Δ_{b} with \tilde{K}=4 is also illustrated in FIG. 3, indicated by the grey columns, consisting of a random selection of RSSI vectors corresponding to the training locations \tilde{c}={x₁, x₂, x₄, x₇}, such that snapshots taken at \tilde{k}={1,2,4,7} and \tilde{s}={2,8,5,8}, yield

$${Δ}_{b} = [ {p}_{1}^{( 2 )} , {p}_{2}^{( 8 )} , {p}_{4}^{( 5 )} , {p}_{7}^{( 8 )} ] {=}^{△} [ {\tilde{p}}_{1} , … , {\tilde{p}}_{4} ] .$$

Next, consider the covariance matrix with structure similar to that of equation (31), but constructed only with respect to the training location vector \tilde{c}_{b}, i.e.,

$${Ψ}_{b} {=}^{Δ} [ \begin{matrix}ϕ ( {\tilde{ρ}}_{1} , {\tilde{ρ}}_{1} \vert θ ) & … & ϕ ( {\tilde{ρ}}_{1} , {\tilde{ρ}}_{\tilde{K}} \vert θ ) \\ ⋮ & ⋱ & ⋮ \\ ϕ ( {\tilde{ρ}}_{\tilde{K}} , {\tilde{ρ}}_{1} \vert θ ) & … & ϕ ( {\tilde{ρ}}_{\tilde{K}} , {\tilde{ρ}}_{\tilde{K}} \vert θ )\end{matrix} ] ∈ {ℝ}^{\tilde{K} \times \tilde{K}} \qquad ( 41 )$$

Then, under the SGD method, the update of the parameter vector θ for the mini-batch Δ_{b} is obtained by the corresponding variations of equations (38) and (40), namely

$${∇}_{b} g ( θ ; {ρ}_{1} , … , {ρ}_{K} ) = \frac{1}{2} [ \begin{matrix}Tr ( {Ψ}_{b}^{- 1} \frac{\partial {Ψ}_{b}}{\partial α} ) \\ ⋮ \\ Tr ( {Ψ}_{b}^{- 1} \frac{\partial {Ψ}_{b}}{\partial {β}_{m}} ) \\ ⋮ \\ Tr ( {Ψ}_{b}^{- 1} \frac{\partial {Ψ}_{b}}{\partial γ} )\end{matrix} ] = {Ψ}_{b}^{- 1} {\tilde{c}}_{b} \cdot [ \begin{matrix}\frac{\partial {Ψ}_{b}}{\partial α} \\ ⋮ \\ \frac{\partial {Ψ}_{b}}{\partial {β}_{m}} \\ ⋮ \\ \frac{\partial {Ψ}_{b}}{\partial γ}\end{matrix} ] \qquad ( 42 )$$

$${θ}^{( i )} ← {θ}^{( i - 1 )} - {λ}_{b} \cdot {∇}_{b} g ( {θ}^{( i - 1 )} ; {ρ}_{1} , … , {ρ}_{K} ) \qquad ( 43 a )$$

$$0 \leq {λ}_{b} \leq {( max eig ( {( {Ψ}_{b}^{- 1} )}^{T} \cdot {Ψ}_{b}^{- 1} ) )}^{- 1} \qquad ( 43 b )$$

A schematic block diagram of the noise-robust parameter θ optimisation method via mini-batch SGD using the data cube mini-batch embodiment is given in FIG. 4 a). The optimisation method is further illustrated in the flow diagram of FIG. 5 a). It is reminded that the method is to be run independently for each coordinate x and y, such that its execution yields the optimized, i.e., trained, parameters θₓ* and θ_{y}*.

Inputs to the training process are the data cube Δ with S snapshots of each an all RSSI vectors

$${ρ}_{k}^{( s )} ,$$

with k∈{1, . . . , K} and s∈{1, . . . , S}, the number B of mini batches, the number

$${i}_{max}^{( B )}$$

of SGD iterations per mini batch, the receiver coordinates

$${c}_{m}^{S} ∀ m ,$$

the reflector coordinates

$${c}_{ℓ}^{R} ∀ ℓ ,$$

the coordinates

$${\hat{c}}_{k}^{T} ∀ \hat{k}$$

of the training nodes, and an initial parameter vector θ⁰, which are received in step 110. In step 120, a mini batch Δ_{b} is taken from the data cube, each mini-batch comprising a number \tilde{K}<<K mutually exclusive training RSSI vectors \tilde{p}_{\tilde{k}} with \tilde{k}∈{1, . . . , \tilde{K}}. Each of the mini batches is fed one by one to a calculation process in step 130. In step 140 the covariance matrix Ψ_{b} is constructed as per equation (41), and in step 150 the gradients ∇_{b} g(θ; p₁, . . . , p_{K}) are computed via equation (42). In step 160 θ is updated as per equation (43). Computing the gradients and updating the intermediate optimised values is iteratively repeated until a termination criterion is met, which is checked in step 170. If the termination criterion is not met, “no”-branch of step 170, the next iteration is carried out. Suitable termination criteria comprise, inter alia, a predetermined maximum number of iterations

$${i}_{max}^{( B )}$$

or a convergence of the intermediate optimised values θ below a predetermined threshold. The convergence criterion may also comprise that such convergence is stable over a predetermined number of subsequent iterations. Once it is determined, in step 170, that the termination criterion is met, “yes”-branch of step 170, step 180 checks if the last one of the B mini batches has been fed to the calculation process. If not, “no”-branch of step 180, the process returns to step 120 and is repeated. If all mini batches have been fed to the calculation process, “yes”-branch of step 180, the training phase is completed, and the optimised values for the weight parameters θ* are output in step 190.

Finally, the actual localisation can be performed. A conventional approach would be to use a known RSSI-based localisation method, e.g., as described in “Machine learning methods for RSS-based user positioning in distributed massive MIMO”, which, in possession of a parameter vector θ obtained through model training, reduces to evaluating equation (20a) for each k-th object, given the corresponding RSSI measurements pₖ obtained at the receivers, the noise-free training RSSI vectors pₖ obtained in the conventional training phase, and the associated covariance matrix Ψ.

An aspect of the present invention benefits from having an optimised parameter vector θ* obtained through the noise-robust approach described above, so that instead of noise-free training RSSI vectors noisy training RSSI vectors are available. In embodiments of the invention, an entire data-cube [symbol] containing multiple snapshots of noisy training RSSI vectors

$${ρ}_{k}^{( s )}$$

is available.

Multiple GP-based localisation methods can be used with the optimised parameter vector θ*. In the following, one exemplary method will be described.

Consider the joint distribution of the coordinate vectors of the training objects and the actual objects to be located, which by leveraging conventional GP methods yields,

$$ℙ ( [ \begin{matrix}C \\ C\end{matrix} ] \vert {ρ}_{1} , … , {ρ}_{K} , {p}_{1} , … , {p}_{K} , {θ}^{*} ) = N ( 0 , [ \begin{matrix}Ψ & {\sum }^{T} \\ \sum & Φ\end{matrix} ] ) \qquad ( 44 )$$

where Σ∈ [symbol] ^{K×K} is the cross-covariance matrix between the training RSS and the actual objects' RSS data, whose element at the k-th row and k th column is given by φ(pₖ, pₖ). In hand of the joint distribution in equation (44), the conditional distribution of c is defined as

[symbol]

(c|c,p₁, . . . ,p_{K},p₁, . . . ,pₖ,θ*)=N(μ,C) (45)

where the conditional mean vector μ∈ [symbol] ^{K×1} and covariance matrix C∈ [symbol] ^{K×K} is obtained via

μ=ΣΨ⁻¹c∈ [symbol] ^{K×1} (46a)

C=Φ−ΣΨ⁻¹Σ^{T}∈ [symbol] ^{K×K} (46b)

Finally, the marginal distribution of the individual object coordinate can be obtained as

[symbol]

(c|c,p₁, . . . ,p_{K},pₖ,θ*)=N(cₖ,vₖ) (47)

where cₖ and vₖ are respectively the marginal mean and variance of the estimate of the coordinate of the k-th object and are given by

$${c}_{k} = {\sum }_{k = 1}^{K} ϕ ( {p}_{k} , {ρ}_{k} ) \cdot {[ {Ψ}^{- 1} c ]}_{k} \qquad ( 48 a )$$

$${v}_{k} = ϕ ( {p}_{k} , {ρ}_{k} ) - {\sum }_{k = 1}^{K} {\sum }_{i = 1}^{K} ϕ ( {p}_{k} , {ρ}_{k} ) \cdot {[ {Ψ}^{- 1} ]}_{k , i} \cdot ϕ ( {ρ}_{i} , {p}_{k} ) \qquad ( 48 b )$$

where the notation [⋅]ₖ and [⋅]_{k,i}, respectively, denote the k-th element of a vector and the matrix element at the k-th row and i-th column.

Since cₖ is Gaussian distributed, the marginalized mean cₖ is directly the maximum-a-posteriori estimate of cₖ, and hence the final predicted coordinate.

FIG. 5 b) shows a flow diagram of an exemplary localisation method. The localisation comprises steps 200 through 240. Inputs to the localisation are the RSS value vectors pₖ for each of the individual k-th object obtained at all M receivers, the receiver coordinates

$${c}_{m}^{S} ∀ m ,$$

the reflector coordinates

$${c}_{ℓ}^{R} ∀ ℓ ,$$

the coordinates

$${\hat{c}}_{k}^{T} ∀ k$$

of the training nodes, and the optimised weight parameters

$${θ}_{x}^{*} and {θ}_{y}^{*} ,$$

which are received in step 200. In step 210 covariance matrices between the training RSS and the actual objects' RSS data are computed via equation (44), and in step 220 the conditional mean and covariance are computed via equations (46a) and (46b), respectively. Next, in step 230, the marginalised mean is computed via equation (48a), which is output in step 240.

In summary, the complete localisation method, including the training phase of the localisation model and the coordinate prediction localisation phase, is described by the method steps illustrated in FIGS. 4 a) and b), and 5 a) and b). In part a) of each figure the main steps of the training process are shown, and in part b) of each figure the main steps of the localisation process are shown. Note that the figures shows an embodiment with mini-batch processing of noisy training data, which is optional to the method.

The effectiveness of the proposed noise-robust localisation method is evaluated via computer simulations, and compared against the method discussed by K. N. R. S. V. Prasad, E. Hossain, and V. K. Bhargava, in “Machine learning methods for RSS-based user positioning in distributed massive MIMO,′ IEEE Transactions on Wireless Communications, vol. 17, no. 12, pp. 8402-8417, 2018, which utilizes conjugate gradient (CG) to train a GPR localisation model with single-path RSS.

Here, the root mean square error (RMSE) of the object coordinates is selected as a target metric to evaluate and compare the localisation performance of the algorithms.

TABLE I
Simulation parameters

| Parameter | Value |
|---|---|
| Path-loss parameters (3GPP UMi) | ${d}_{0} = 10 m \\ {b}_{0} = - 47.5 dB \\ η = \{ \begin{matrix}0 , & if {d}_{mk} < 10 m \\ 2 , & if 10 m \leq {d}_{mk} \leq 45 m \\ 6.7 , & otherwise\end{matrix}$ |
| UE transmit power | 21 dBm (125 mW) |
| Noise power | −107.5 dBm |
| Receiver sensitivity | −106.5 dBm |

Table I shows the system parameters used in the simulation. The path-loss parameters d₀, b₀, and η are defined by the 3GPP Urban Micro propagation model as defined in 3GPP, “Evolved Universal Terrestrial Radio Access (E-UTRA); Further advancements for E-UTRA physical layer aspects,” 3rd Generation Partnership Project (3GPP), Technical Report (TR) 36.814, 032017 version 9.2.0., and the transmit power p of 21 dBM (125 mW) is defined by LTE standards, e.g., as discussed by J. Salo, M. Nur-Alam, and K.-K. Chang, in “Practical introduction to LTE radio planning”, 2010. In addition, the noise power in the system is defined as −107.5 dBm with a receiver sensitivity of −106.5 dBm, meaning that if the RSS at a receiver is below the receiver sensitivity, the signal is assumed to have noise power.

FIG. 6 shows an exemplary representation of the scenario considered in the simulation and the localisation result provided by the method proposed herein. The target, or object, is shown as a diagonal cross, while a number of reflectors are shown as circles. The environment has a number of receivers RHH, shown as squares along the sides of the exemplary road cross. The training positions on the crossing roads are shown as dots. The considered scenario of the simulation is a street intersection with an ROI of 100 m×100 m. In the illustrated scenario, M=56 sensor RRHs are positioned along the roadside, with \hat{K}=204 training positions distributed in a uniform grid on the road. In addition, the localization results are shown for the proposed algorithm with only a small number of RRHs, for illustration purposes.

FIG. 7 shows a comparison of the RSME of the proposed method with the prior art method mentioned above as a function of the noise variance, in addition to illustrating the effect of increasing the number of paths L via introducing reflectors to the scenario. The prior art methods, indicated as ‘SotA’ in the figure, are based on CG and SGD, respectively. Multiple important points can be observed from the plot. First, the performance of the proposed method, abbreviated “prop.” and represented by the squares, is shown to outperform the prior art methods, represented by the circles, irrespective of the number of paths, which can be owed to the proposed incorporation of artificial noise parameters to the training data, to increase the robustness to shadowing noise.

To corroborate the point, the performance results are also shown for a variant of the known method, shown in white circular nodes, where the CG optimisation is replaced with the mini-batch SGD, such that the only difference between the proposed method and the known method is the noise-robust training phase. While the known method with mini-batch SGD slightly improves the performance of the method, it is observed that there is still significant gain of the proposed method.

Next, FIG. 8 illustrates the effect of decreasing the total number of receivers, given that there is a reflector to increase the diversity in the received RSS. The results show that for L=2, the RMSE performance of the L=1 case can be reached even with 66% of the number of receivers, which supplements the hypothesis that introducing passive reflectors can reduce the total number of required receivers in the system to achieve a given performance.

In light of the foregoing discussion, in a first aspect of the present invention a method of locating one or more objects emitting wireless signals, in an environment having at least two receivers adapted to at least determine RSS values of the one or more object's wireless signals is presented. The at least two receivers have known positions in the environment and are communicatively connected to a common computing unit. The method comprises, at the common computing unit, determining an optimised RSS value-based coordinate mapping function for the environment under consideration of line-of-sight (LOS) paths and non-line-of-sight (NLOS) paths, using the known positions of the receivers, reflectors and training objects. The training objects and their signals may be simulated. The training data may comprise training samples taken over time and/or noisy training samples, at least some of the training samples differing from each other. The method further comprises aggregating RSS values for each of the one or more objects and from each of the two or more receivers, including RSS values of NLOS signals, or multipath signals, and arranging the aggregated RSS values into received signal power vectors representing the RSS values of all of the one or more objects as determined in each of the receivers. The method yet further comprises mapping, for each object, vectors containing the RSS values received by the two or more receivers onto x- and y-coordinates of the environment using the optimised mapping function.

In one or more embodiments of the method, the optimised coordinate mapping function is derived by a Gaussian Process using the mean and covariance of the RSS values of the training objects as input.

In one or more embodiments of the method, determining the optimised mapping function comprises determining a conditional distribution of the coordinates of the training transmitters and the actual transmitters, and determining a marginal distribution of the coordinates therefrom using weight parameters determined in a training phase.

In one or more embodiments of the method determining parameters of the optimised coordinate mapping function comprises iteratively processing small batches of training data sets. The processing may contain a stochastic gradient descent process. The data sets may comprise subsets of a series of samples and/or noisy data.

In one or more embodiments of the method determining the optimised coordinate mapping function for the environment comprises treating each RSS value per line-of-sight (LOS) path and non-line-of-sight (NLOS) path as a single, separate object. This may also comprise individually localising all single, separate objects, irrespective of from a LOS or NLOS path, and employing a probability or clustering process for determining localised objects that correspond to the same actual physical object.

In one or more embodiments of the method determining an optimised coordinate mapping function comprises generating a cross-covariance matrix for the 2D-coordinates from training values of all training objects subject to weight parameters, and optimising the weight parameters by applying a stochastic gradient descent (SGD) process.

In one or more embodiments the wireless signals are wireless communication signals that carry information for determining identities of the object that transmitted a respective wireless communication signal.

In accordance with a second aspect of the present invention a receiver configured for use with the method presented hereinbefore is presented. The receiver comprises one or more software and/or hardware blocks configured for receiving a wireless signal from one or more objects emitting such signals, for determining at least an RSS value for the received signals, and for transmitting the signals to a common computing unit.

The receiver may comprise one or more antennas for receiving wireless signals from multiple objects, one or more microprocessors, volatile and non-volatile memory, which are connected through one or more communication lines or buses. The non-volatile memory stores computer program instructions which, when executed by the one or more microprocessors, configure the one or more microprocessors to control the software or hardware blocks or modules, or the combination thereof, to execute the method in accordance with an aspect of the invention presented hereinbefore.

The receiver may further be configured for extracting information for determining identities of the object that transmitted a respective wireless communication signal, and for providing said information to the common computing unit, along with the respective RSS values.

In accordance with a third aspect of the present invention a common computing unit configured is presented. The common computing unit comprises one or more microprocessors, volatile and non-volatile memory, and an interface for communicatively coupling with two or more receivers in accordance with the second aspect of the invention, wherein the non-volatile memory stores computer program instructions which, when executed by the microprocessor, configure the common compute unit to execute the method in accordance with embodiments of the first aspect of the invention.

The methods described hereinbefore may be represented by computer program instructions. Accordingly, a computer program product comprises computer program instructions which, when executed by a microprocessor of a receiver, cause the microprocessor to operate the receiver to at least determine RSS values of wireless signals of one or more objects and to communicate the RSS values to the common computing unit, and to accordingly control hardware and/or software blocks or modules of the receiver. When executed by a microprocessor of a common computing unit, the program instructions cause the microprocessor to execute the method in accordance with the first aspect of the present invention, and to accordingly control hardware and/or software blocks or modules of the common computing unit.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

The method and apparatus proposed herein provide a basis for object localisation based on RSS values of wireless signals emitted from the objects, in particular vehicles-autonomous or under human control. The improved performance is achieved, inter alia, by performing ML-based training including training signals for NLOS signal paths and known positions of reflectors. Training the model using noisy training data and/or distributing the training data into mini batches, which are then fed to a stochastic gradient descent algorithm, leads to a further improvement of the accuracy and/or to reduced requirements as to the number of receivers.

The method and apparatus proposed herein can be used in any wireless communication system environment, in particular in 6G communication systems and beyond, in indoor and outdoor environments, including industrial scenarios.

### BRIEF DESCRIPTION OF THE DRAWING

The figures in the attached drawing are used for detailing aspects of the present invention. In the drawing

FIG. 1 shows a schematic representation of a system in accordance with an aspect of the invention comprising a common computing unit, multiple receivers and multiple objects,

FIG. 2 illustrates the concept of LOS and NLOS signal paths between a transmitter and a receiver,

FIG. 3 illustrates the training data cube,

FIG. 4 shows exemplary block diagrams of the major training and localisation steps,

FIG. 5 shows a flow diagram of an exemplary embodiment of the method in accordance with an aspect of the invention,

FIG. 6 shows an exemplary scenario used in a simulation,

FIG. 7 shows a comparison of the RSME of the proposed method with prior methods as a function of the noise variance,

FIG. 8 shows RMSE of the estimated coordinates of the proposed algorithm, with varying number of receivers,

FIG. 9 shows an exemplary schematic block diagram of a receiver in accordance with an aspect of the invention, and

FIG. 10 shows an exemplary schematic block diagram of a common computing unit in accordance with an aspect of the invention.

In the figures, identical or similar elements may be referenced using the same reference designators.

### DETAILED DESCRIPTION OF EMBODIMENTS

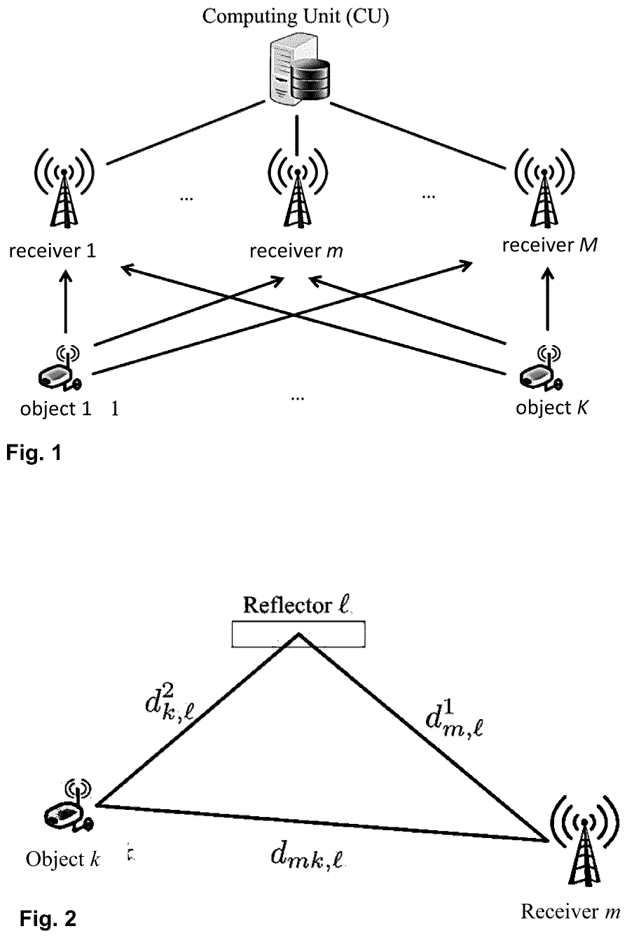

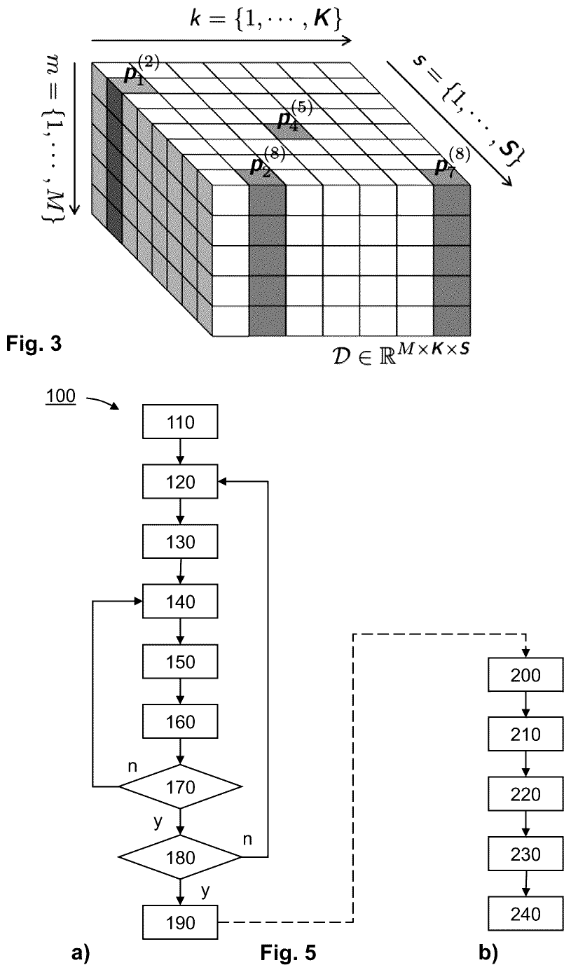

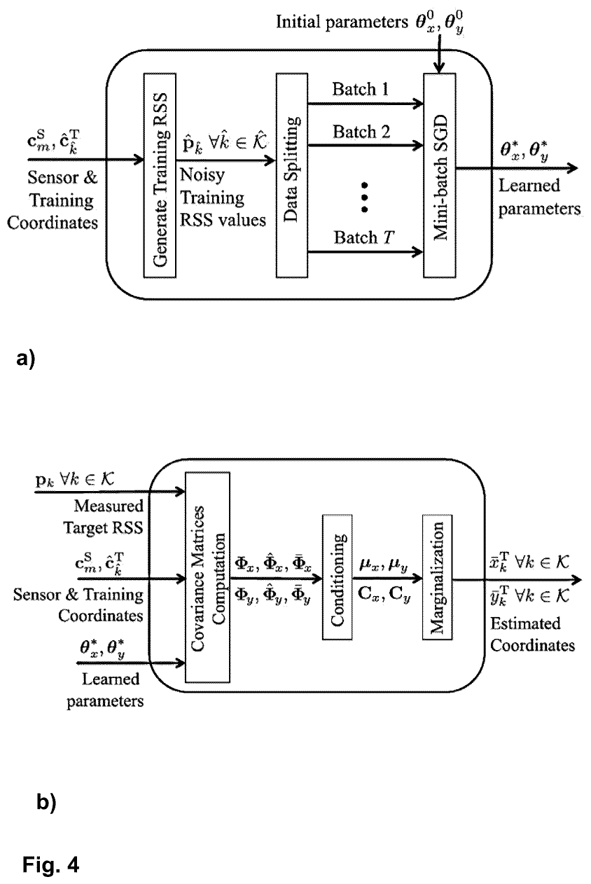

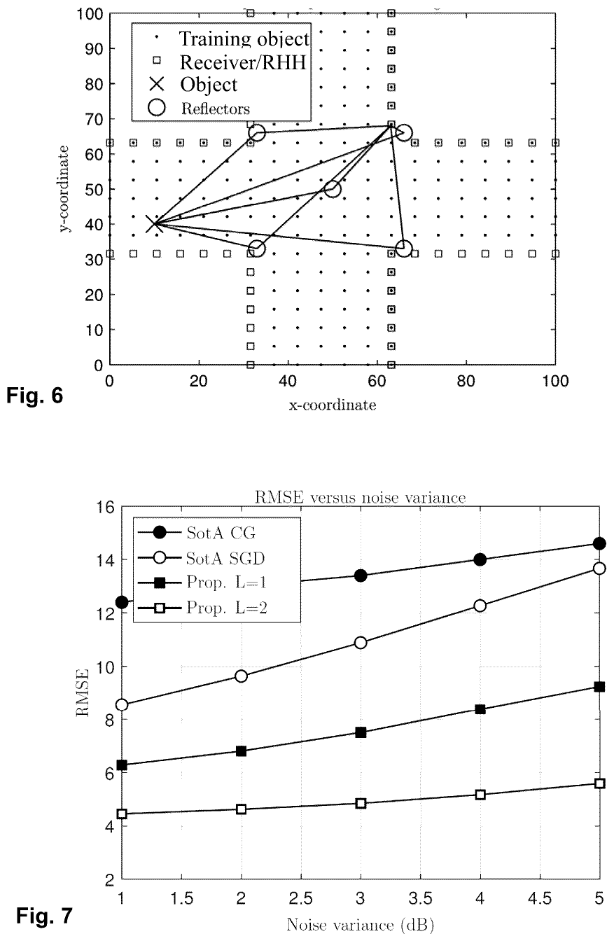

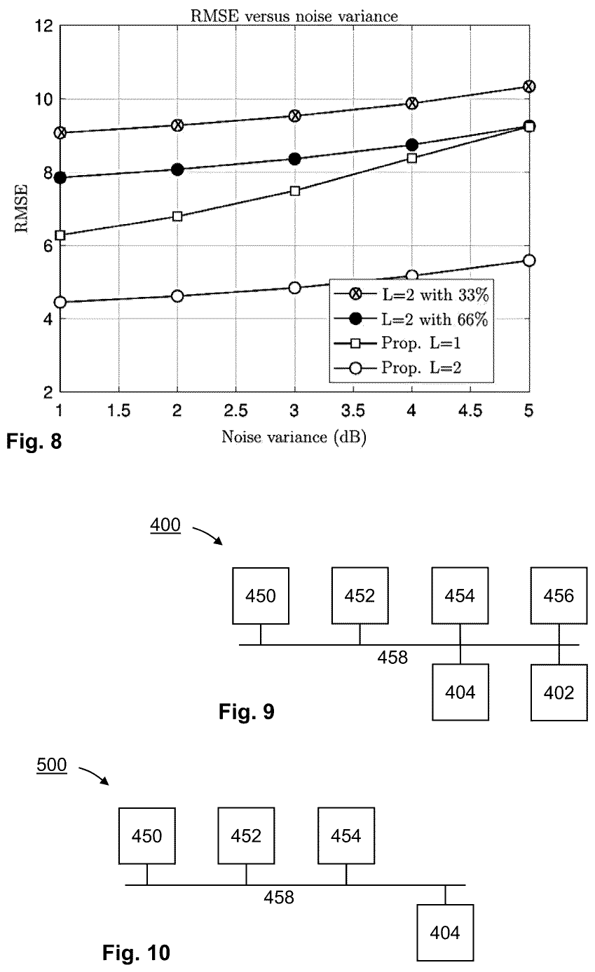

FIGS. 1 to 8 have been described further above and will not be discussed again.

FIG. 9 shows an exemplary schematic block diagram of a receiver, or RHH, 400 in accordance with an aspect of the present invention. The receiver 400 comprises one or more antennas 402 and associated wireless interface circuitry 456, adapted to receive wireless signals from one or more objects, one or more microprocessors 450, volatile memory 452, non-volatile memory 454, and a communication interface 404 for communicating with a common compute unit 500. The aforementioned elements are communicatively connected via one or more signal or data connections or buses 458. The non-volatile memory 454 stores computer program instructions which, when executed by the microprocessor 450, cause the receiver 400 to at least determine RSS values of wireless signals of one or more objects and to communicate the RSS values to the common computing unit 500.

FIG. 10 shows an exemplary schematic block diagram of a common computing unit 500 in accordance with an aspect of the present invention. The common computing unit 500 comprises one or more microprocessors 450, volatile memory 452, non-volatile memory 454, and a communication interface 404 for communicating with two or more receivers 400. The aforementioned elements are communicatively connected via one or more signal or data connections or buses 458. The non-volatile memory 454 stores computer program instructions which, when executed by the microprocessor 450, cause the common computing unit 500 to execute the method according to embodiments of the first aspect of the invention as presented hereinbefore.

LIST OF REFERENCE NUMERALS
(PART OF THE DESCRIPTION)

| | |
|---|---|
| 100 | method |
| 110 | receive input data |
| 120 | take mini batch from data cube |
| 130 | feed mini batch to calculation process |
| 140 | construct covariance matrix |
| 150 | compute gradients |
| 160 | update intermediate optimised values |
| 170 | termination criterion met? |
| 180 | termination criterion met? |
| 190 | output optimised weight parameters |
| 200 | receive input data |
| 210 | compute covariance matrices |
| 220 | compute conditional mean and covariance matrices |
| 230 | compute marginalised mean |
| 240 | output marginalised mean |
| 400 | receiver/RHH |
| 402 | antenna |
| 404 | interface |
| 450 | microprocessor |
| 452 | volatile memory |
| 454 | non-volatile memory |
| 456 | wireless interface circuitry |
| 458 | signal/data connection/bus |
| 500 | common computing unit/CU |

1. A method of locating one or more objects emitting wireless signals, in an environment having at least two receivers adapted to at least determine RSS values of the one or more object's wireless signals, the at least two receivers having known positions in the environment and being communicatively connected to a common computing unit, the method comprising, at the common computing unit:
determining an optimised RSS value-based coordinate mapping function for the environment under consideration of line-of-sight paths and non-line-of-sight paths, using the known positions of the receivers, reflectors and training objects,
aggregating RSS values for each of the one or more objects and from each of the two or more receivers, including RSS values of LOS and NLOS signals, or multipath signals,
arranging the aggregated RSS received signal power vectors representing the RSS values of all of the one or more objects as determined in each of the receivers, and
mapping, for each object, vectors containing the RSS values received by the two or more receivers onto x- and y-coordinates of the environment using the optimised mapping function.

2. The method of claim 1, wherein the training data comprises training samples taken over time and/or noisy training samples, at least some of the training samples differing from each other.

3. The method of claim 1, wherein the optimised coordinate mapping function is derived by a Gaussian Process using the mean and covariance of the RSS values of the training objects as input.

4. The method of claim 1, wherein determining the optimised mapping function comprises determining a conditional distribution of the coordinates of the training transmitters and the actual transmitters, and determining a marginal distribution of the coordinates therefrom using weight parameters determined in a training phase.

5. The method of claim 1, wherein determining parameters of the optimised coordinate mapping function comprises iteratively processing small batches of training data sets.

6. The method of claim 1, further comprising determining the optimised coordinate mapping function for the environment comprises treating each RSS value per line-of-sight path and non-line-of-sight path as a single, separate object.

7. The method of claim 6, further including individually localising all single objects, irrespective of from a LOS or NLOS path, and employing a probability or clustering process for determining localised objects that that correspond to the same actual physical object.

8. The method of claim 1, wherein determining an optimised coordinate mapping function comprises generating a cross-covariance matrix for the 2D-coordinates from training values of all training objects subject to weight parameters, and optimising the weight parameters by applying a stochastic gradient descent process.

9. The method of claim 1, wherein the wireless signals are wireless communication signals that carry information for determining identities of the object that transmitted a respective wireless communication signal.

10. A receiver of a wireless communication system comprising one or more antennas and associated receiving circuitry, one or more microprocessors, volatile and non-volatile memory, and an interface for communicatively coupling with a common computing unit, wherein the non-volatile memory stores computer program instructions which, when executed by the microprocessor, configure the receiver to at least determine RSS values of wireless signals of one or more objects and to communicate the RSS values to the common computing unit.

11. The receiver of claim 10, wherein the computer program instructions, when executed by the microprocessor, configure the receiver to determine an identifier of the one or more objects and to communicate the identifier along with the RSS values to the common computing unit.

12. A common compute unit of a wireless communication system comprising two or more receivers in accordance with claim 10, the common compute unit comprising one or more microprocessors, volatile and non-volatile memory, and an interface for communicatively coupling with two or more receivers, wherein the non-volatile memory stores computer program instructions which, when executed by the microprocessor, configure the common compute unit to execute a method of locating one or more objects emitting wireless signals, in an environment having the at least two receivers adapted to at least determine RSS values of the one or more object's wireless signals, the at least two receivers having known positions in the environment and being communicatively connected to the common computing unit, the method comprising, at the common computing unit:
determining an optimised RSS value-based coordinate mapping function for the environment under consideration of line-of-sight (LOS) paths and non-line-of-sight (NLOS) paths, using the known positions of the receivers, reflectors and training objects,
aggregating RSS values for each of the one or more objects and from each of the two or more receivers, including RSS values of LOS and NLOS signals, or multipath signals,
arranging the aggregated RSS received signal power vectors representing the RSS values of all of the one or more objects as determined in each of the receivers, and
mapping, for each object, vectors containing the RSS values received by the two of more receivers onto x- and y-coordinates of the environment using the optimised mapping function.

13. A computer program product comprising computer program instructions which, when executed by a microprocessor, cause a computer and/or control hardware blocks, modules or components of a receiver in accordance with claim 10 of a wireless communication system comprising one or more antennas and associated receiving circuitry, one or more microprocessors, volatile and non-volatile memory, and an interface for communicatively coupling with a common computing unit, wherein the non-volatile memory stores computer program instructions which, when executed by the microprocessor, configure the receiver to at least determine RSS values of wireless signals of one or more objects and to communicate the RSS values to the common computing unit to at least determine the RSS values of wireless signals of one or more objects and to communicate the RSS values to the common computing unit.

14. A non-transitory readable medium retrievably transmitting or storing the computer program product of claim 13.

15. A wireless communication system comprising two or more receivers of a wireless communication system comprising one or more antennas and associated receiving circuitry, one or more microprocessors, volatile and non-volatile memory, and an interface for communicatively coupling with a common computing unit, wherein the non-volatile memory stores computer program instructions which, when executed by the microprocessor, configure the receiver to at least determine RSS values of wireless signals of one or more objects and to communicate the RSS values to the common computing unit, which are communicatively connected to a common compute unit in accordance with claim 12.
